(19) United States
(12) Patent Application Publication
(10) Pub. No.: US 2010/0230624 A1
(43) Pub. Date: Sep. 16, 2010

(54) Ball valve with a flat mounting face

(76) Inventor: Cesar Tejamo, Stockton, CA (US)

Correspondence Address: CESAR TEJAMO, 146 W. 3rd St., Stockton, CA, 95206, US

(21) Appl. No.: 12/381,536

(22) Filed: Mar. 11, 2009

(51) Int. Cl. F16K 5/08

(52) U.S. Cl. 251/315.16

(57) ABSTRACT

A ball valve with fluid communicating ports, namely a first port and subsequent port or ports has a valve body having faces, one of the faces namely the mounting face is generally flat, a bore on the said mounting face defines the location of said first port. A number of mounting holes are provided near the edges of the valve body, the axes of said mounting holes are generally perpendicular to said mounting face.

### FIELD OF INVENTION

This invention relates to ball valves, specifically to ball valves that mount onto a flat surface.

### BACKGROUND OF THE INVENTION

The overall size of a machinery or an equipment is a very important factor to consider during its design stages. The smaller space it occupies, the better. In order to achieve this, components are located close to each other and it must occupy the smallest amount of space and yet easy to assemble and maintain. Some of these machineries or equipments have a number of components that are hot or becomes hot during operation and needs a cooling system to keep it running efficiently. These components that are hot or known to get hot are provided with cooling jackets or cooling plates so that cooling fluid, usually water can be routed to them. A typical cooling system to provide water to multiple components is by routing water to an inlet port of a supply manifold, water is then distributed through multiple distribution ports of the manifold, route the water through pipes or hoses to water jackets then back to the ports of the return manifold. To control the flow of water to individual water jackets, valves, generally ball valves are installed on the distribution ports of the manifolds.

Heretofore, most ball valves had been provided with threads, mostly pipe threads on all fluid communicating ports. To make connections to a manifold one of the valve's ports is mated to a matching thread on the manifold. In order to create a leak-free connection, each valve had to be rotated until the mating threads are tight. Due to thread tolerances and other inconsistencies in the fabrication of the pipe threads, it is impossible to maintain a consistent, predetermined position of the ball valve relative to each other or the manifold. While the application of a pipe putty on the joints may help achieve a leak-free connection and maintain a not very consistent but acceptable valve position, a long cure time required for the putty makes it undesirable for use. Another drawback against the use of putty is that it will take a considerable amount of time to clean the surfaces when replacing a valve. The use of putty may also contaminate the fluid, which is not acceptable in ultra clean applications.

Prior art flanged ball valves had been fitted with standard flanges, generally ASME B16.5 series flanges, on all ports. While these ball valves can maintain a predetermined position and make a tight seal without the rotating motion of the ball valve, the physical size is substantially large. The use of standard flanges on all ports of the ball valve limits the connection fitting to be of flange type only. This makes it undesirable to use since flanged fittings are not readily available on pipe sizes smaller than ½ inch. Due to the physical size of the standard flanges and its lack of availability on pipe sizes less than ½ inch, it cannot be effectively used on applications requiring a small installed space.

### SUMMARY

The present invention has been made to correct the problems above. It is the object of this invention to provide a ball valve that can be installed leak-free, unto a flat surface at a predetermined position and occupies a very small amount of space available for a given size valve.

Another object of this invention is to be able to install multiple valves, side by side, closely together.

It is another object of this invention to create a ball valve that can result in a leak-free connection without the rotating motion of the valve during installation.

Another object of this invention is to create a ball valve that is clean and very easy to install and uninstall.

### BRIEF DESCRIPTION OF THE DRAWINGS

FIG. 1 shows a perspective view of the preferred embodiment;

FIG. 2 is a front elevation view of the preferred embodiment;

FIG. 3 shows a cross sectional view taken along line A-A of FIG. 2, constructed in accordance with the preferred embodiment of the invention;

FIG. 4 is a cross sectional view of the valve of the preferred embodiment mounted on a manifold;

FIG. 5 is a cross sectional view of another embodiment of the retainer shown in FIG. 3 of the preferred embodiment;

FIG. 6 is a perspective view of another embodiment of the valve shown in FIG. 1;

FIG. 7 is a front elevation view of the valve shown in FIG. 6;

FIG. 8 shows a cross sectional view of another embodiment of the valve shown in FIG. 3;

FIG. 9 is the cross sectional view of the valve shown in FIG. 8 mounted on a manifold;

FIG. 10 is a cross sectional view of another embodiment of the valve body shown in FIG. 8.

### DETAILED DESCRIPTION OF THE DRAWINGS

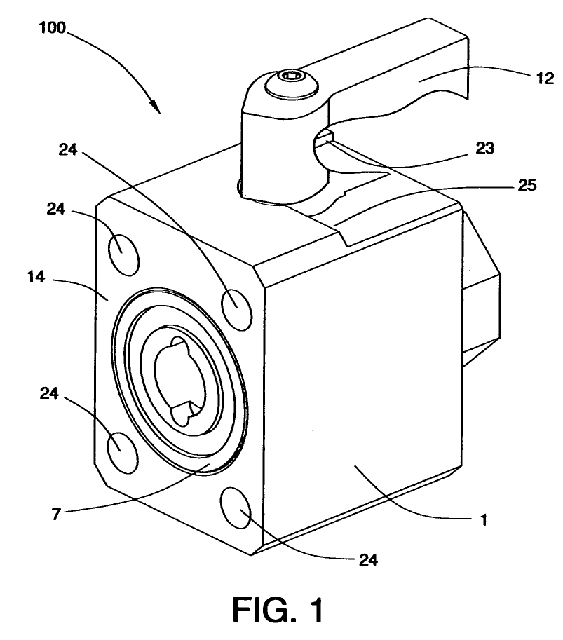

Referring to FIGS. 1-4 of the preferred embodiment, the present invention relates to valve 100 having a flat mounting face configured to mount and seal positively onto a flat surface. The valve assembly 100 in this embodiment is a floating ball style design in which the ball is partially captured between concave surfaces of the seal rings and held in a chamber by a retainer wherein the ball can be operated between open and close by the stem that extends outside of the body. A handle is attached suitably on the outside end of the stem for manual actuation of the valve. Although a short handle is shown, the valve can be fitted with a long handle as well. It should be recognized that the valve stem can be actuated by automatic means. Although this specification is shown and written in terms of two-way straight flow ball valves, it should be further recognized that the invention and principles relating hereto is equally applicable to 3-way valves, angle valves and plug valves. Moreover it will be recognized that some or all of the drawings attached are representation for purposes of illustration only and do not necessarily depict the actual relative sizes or locations of the elements shown. Some of the elements of the ball valve assembly 100 are conventional and the details thereof need not be repeated herein. The present invention is directed to improvements in the design of the valve body and retainer, and these improvements will be described in detail herein.

FIG. 1 is a perspective view of valve 100 showing valve body 1 that has generally flat faces, where one of the faces, designated a mounting face 14 defines the location of one of the fluid communicating ports. Although valve body 1 shown has an outside shape resembling a rectangular block, some portions can be reduced to form a shape, generally cylindrical, starting at some suitable distance from the mounting face, creating a mounting flange. The side opposite the mounting face has a multi-sided protrusion, generally octagonal, and it is the location of the subsequent fluid communicating port. A number of mounting holes 24 are disposed near the edges of the body, the axes of which are generally perpendicular to the mounting face 14 of valve body 1. Valve members that are located internally in valve 100 are kept functionally in place by a retainer 7 and detailed illustrations of the same will be shown in later figures. Valve 100 is also shown with handle 12 that can be operated between valve full open and full close positions, the said open or close positions are defined when lower portion of handle sides are against edges 23 or 25 of said valve body 1.

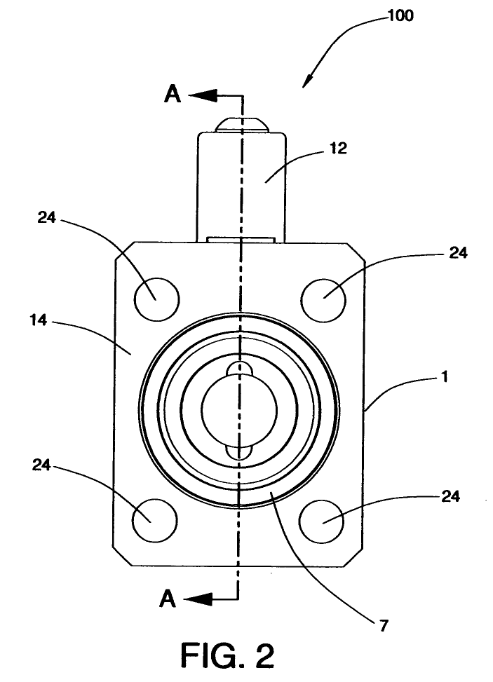

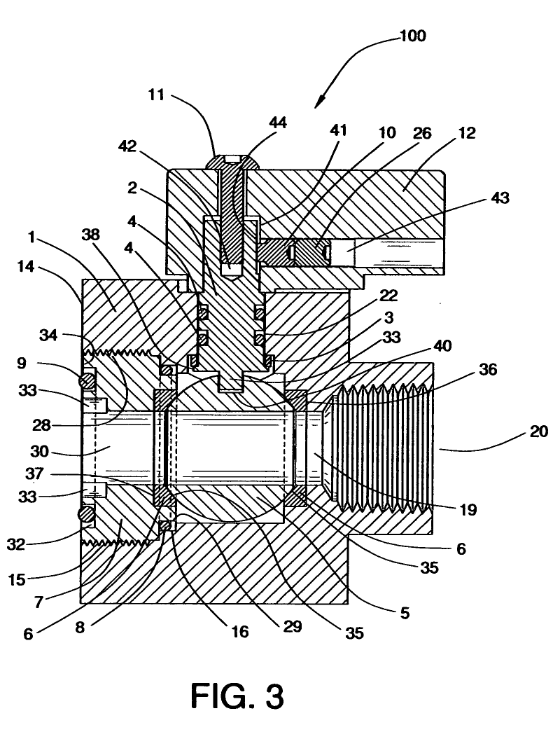

FIG. 2 is a front elevation view of valve 100 showing a section line A-A for the cross sectional view shown in FIG. 3. Description of FIG. 2 had been mentioned in the illustration of FIG. 1 and therefore will not be repeated herein.

FIG. 3 is a cross sectional view of ball valve 100 that includes a valve body 1 having a cavity with radially stepped recesses that is configured to receive the internal valve members, the said internal valve members are captured inside the said cavity of said valve body 1 by retainer 7. The first recess of valve body 1 is on mounting face 14, the wall of said first recess is generally threaded creating threaded wall 15. The second recess is at the base of the first recess, creating a cylindrical sealing surface 16, which has a diameter smaller than the minor diameter of the threads of threaded wall 15. The third recess has a diameter smaller than the diameter of the second recess and provides a portion of the cavity for passage and receipt of valve ball member 5. The fourth recess creates a portion of the cavity for receiving one of the sealing rings 6. The fifth recess is a through hole 19, which forms part of the fluid passageway of the valve. The side opposite mounting face 14 is provided with a threaded hole 20, generally a pipe thread and this is generally designated the outlet port of the valve. Directly above the valve ball cavity is a shouldered opening 22, that extends outward and provides a passage of stem member for valve actuation.

Ball valve 100 shown in FIG. 3 also shows retainer 7 having a cylindrical body with an outside threaded surface 28, an inner section with a reduced diameter creating surface 29, and a through hole 30 which forms the first port, alternately called the inlet port of the valve. The inner end of retainer 7 is also provided for receiving a seal ring 6. Retainer 7 is also provided with groove 32, generally radial, on outer face 34. The outside face of retainer 7 is further provided with a void means for wrench engagement generally a pair of opposing notches 33 at the edge of first port 30.

Still referring to FIG. 3, when valve 100 is assembled, retainer 7 will exert a compressive force on seal rings 6, and ball 5 thereby sealing their contact surfaces. Backup seal 8 between surface 29 of retainer 7 and surface 16 of valve body 1 provides a secondary seal in case of premature wear on contact surfaces 35, 36 and 37. In the assembled condition, surface 34 of retainer 7 should be flush or slightly below surface 14 of valve body 1. Stem 2 is sealed and resiliently centered in opening 22 of body 1 by seals 4. Stem 2 is also held in its vertical position by thrust washer 3, which sets above flange 38 of stem 2, and base of handle 12. The inner end 33 of stem 2 engages loosely into slot 40 on top of ball 5. Hole 41 of handle 12 locates over the outer end of stem 2 and fastened by means of screw 11 engaging on threaded hole 42 of stem 2. Set screw 10 on threaded hole 43 maintains the radial position of handle 12 relative to stem 2 by engaging on the flat surface 44 of stem 2. Set screw 26 retains set screw 10 in place. Radial position of said handle 12 relative to said stem 2 can also be maintained by providing a cooperating flat on hole 41 of handle 12.

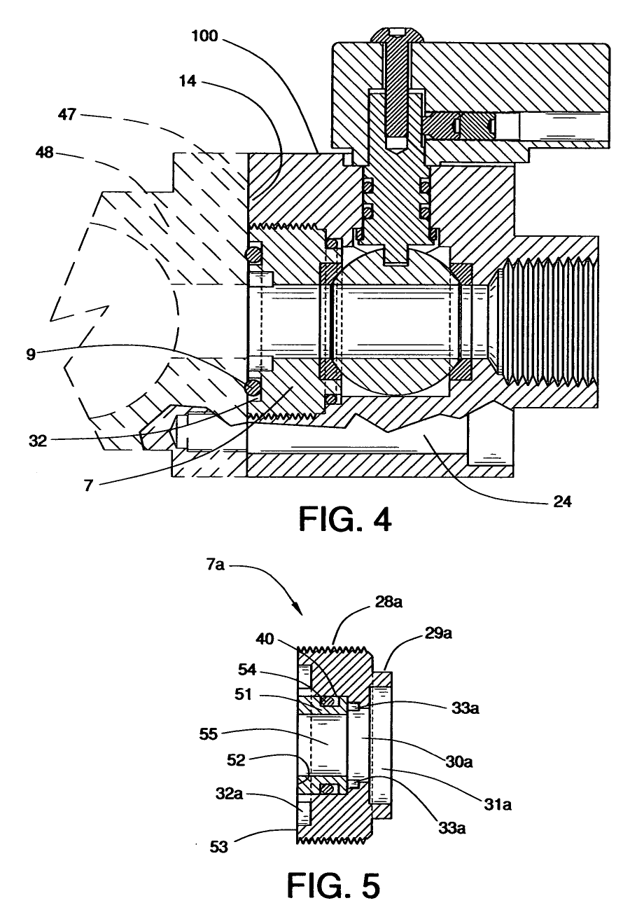

FIG. 4 shows ball valve 100 with its mounting face 14 against a flat face 47 of a manifold 48. Mounting seal 9 on groove 32 of retainer 7 provides a leak-free connection between valve 100 and manifold 48 when mounting screws (not shown) inserted in mounting holes 24 of valve 100 engaging on the threaded holes of manifold 48 are tightened. The advantages of valve 100 with flat mounting face is now apparent over conventional valves with threaded ports when mounting to a manifold or body that has a flat mating surface.

FIG. 5 shows another embodiment of retainer 7 shown in FIG. 3. Retainer 7a includes a body having an outside cylindrical surface 28a, generally threaded, a reduced diameter section creating surface 29a, recess 31a for receiving a seal ring, a through hole 30a for fluid passageway, a groove 32a, generally radial, for receiving a sealing material, recess 40, and a void means for wrench engagement, generally a pair of opposing notches 33a, at the base of recess 40. Retainer 7a further includes an annulus 51 having an outside diameter that fits snugly in recess 40, an inside diameter alternately called orifice 55, an outside surface 52 which when installed, should be flush or slightly below surface 53 of retainer 7a. The said annulus is provided with a groove on the outside diameter for receiving seal 54 to prevent fluid flow bypass and prevents annulus 51 from falling off during handling.

When retainer 7a is used in valve 100, instead of retainer 7, the said valve 100 will have the capability of providing a reduced flow by changing annulus 51 with a smaller orifice 55.

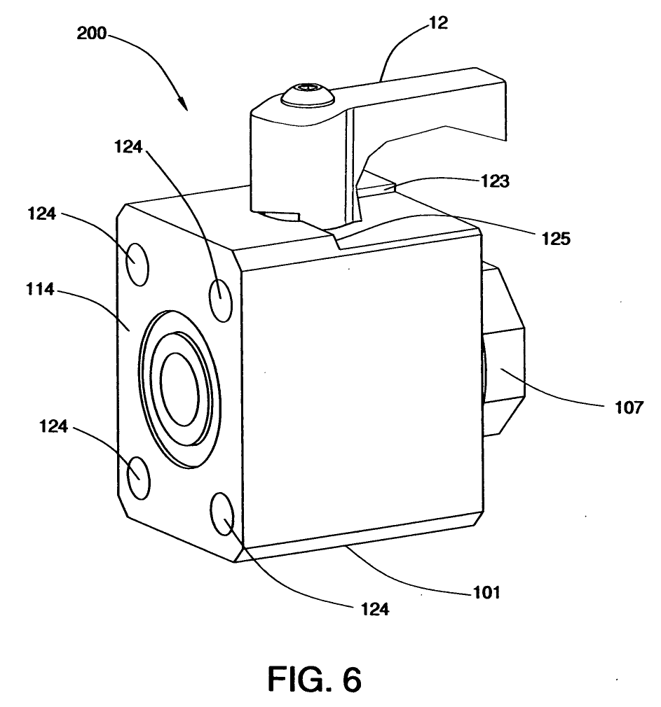

FIG. 6 is a perspective view of valve 200 showing valve body 101 that has generally flat faces, where one of the faces, designated a mounting face 114 is the location of one of the fluid communicating ports. Although valve body 101 shown has an outside shape resembling a rectangular block, some portions can be reduced to form a shape, generally cylindrical, starting at some suitable distance from the mounting face, creating a mounting flange. A number of mounting holes 124 are disposed near the edges of the valve body, the axes of which are generally perpendicular to the mounting face 114 of valve body 101. Valve members that are located internally in valve 200 are kept functionally in place by retainer 107. Retainer 107 is also the location of the subsequent fluid communicating port. Valve 200 is also shown with handle 12 that can be operated between valve full open and full close positions, the said open or close positions are defined when lower portion of handle sides are against edges 123 or 125 of body 101.

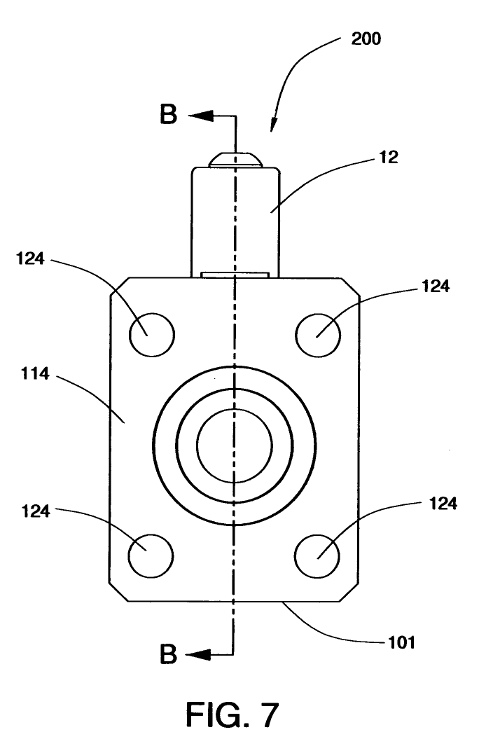

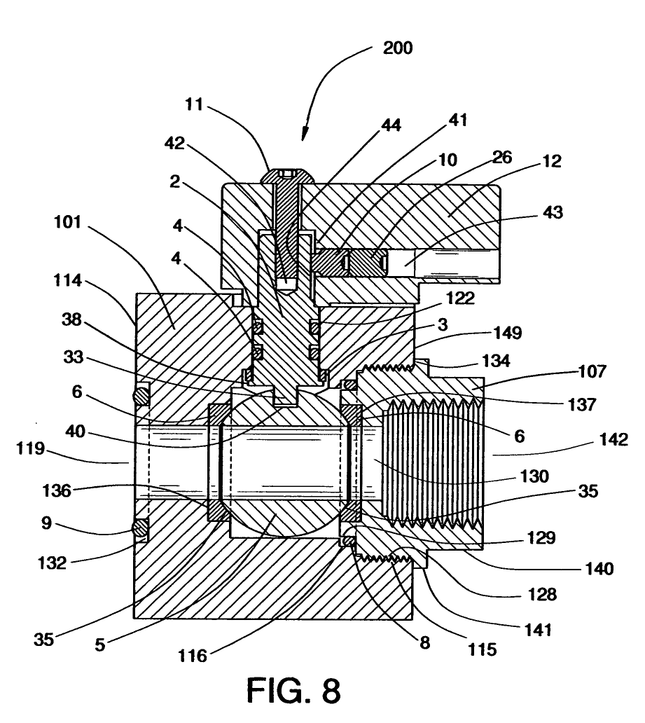

FIG. 7 is a front elevation view of valve 200 showing a section line B-B for the cross sectional view on FIG. 8. Description of FIG. 7 had been mentioned in the illustration of FIG. 6 and therefore will not be repeated herein.

FIG. 8 shows across sectional view of another embodiment of the valve shown in FIG. 3. Valve 200 includes a valve body 101 having a cavity with radially stepped recesses that is configured to receive the internal valve members, the said internal valve members are captured inside the said cavity of said valve body 101 by retainer 107. The first of the said recesses of valve body 101 is on the rear face 149, the wall of the said first recess is threaded creating threaded wall 115. The second recess creates a cylindrical sealing surface 116. The third recess has a diameter smaller than the diameter of the second recess and provides a portion of the cavity for passage and receipt of valve ball member 5. The fourth recess creates a portion of the cavity for receiving a sealing ring 6. The fifth recess is a through hole 119, alternately called first port, which forms part of the fluid passageway of valve 200. A groove 132, generally radial, on mounting face 114 of valve body 101 provides a cavity for receiving mounting seal 9. Directly above the valve ball cavity is a shouldered opening 122 that extends outward and provides a passage of a stem member for valve actuation.

Ball valve 200 shown in FIG. 8 shows a detail of retainer 107 with a body comprising a section 140, generally octagonal, a flange 141, generally circular, a cylindrical threaded surface 128 with a major diameter less than flange 141 creating vertical surface 134, a section with a reduced diameter, creating surface 129, a recess for receiving a seal ring 6, a through hole 130 for fluid passageway, and a threaded hole 142, generally a pipe thread, which will form the outlet port.

Still referring to FIG. 8, when valve 200 is assembled, retainer 107 will exert a compressive force on the seal rings 6 and ball 5 thereby sealing their contact surfaces. Backup seal 8 between surface 129 of retainer 107 and surface 116 of valve body 101 provides a secondary seal in case of premature wear on contact surfaces 35, 136, and 137. When assembled, vertical surface 134 of retainer 107 rest against surface 149 of valve body 101. A small amount of thread locking compound may be applied between mating threads 115 of valve body 101, and 128 of retainer 107. Stem 2 is sealed and resiliently centered in opening 122 of valve body 101 by o-rings 4. Stem 2 is also kept in its position by thrust washer 3, which sets above flange 38 of stem 2 and base of handle 12. The inner end 33 of stem 2 engages loosely into slot 40 on top of ball 5. Hole 41 of handle 12 locates over the outer end of stem 2 and fastened by means of screw 11 engaging on threaded hole 42 of stem 2. Set screw 10 on threaded hole 43 maintains the radial position of handle 12 relative to stem 2 by engaging on the flat surface 44 of stem 2. Set screw 26 retains set screw 10 in place. Radial position of said handle 12 relative to said stem 2 can also be maintained by providing a cooperating flat on hole 41 of handle 12.

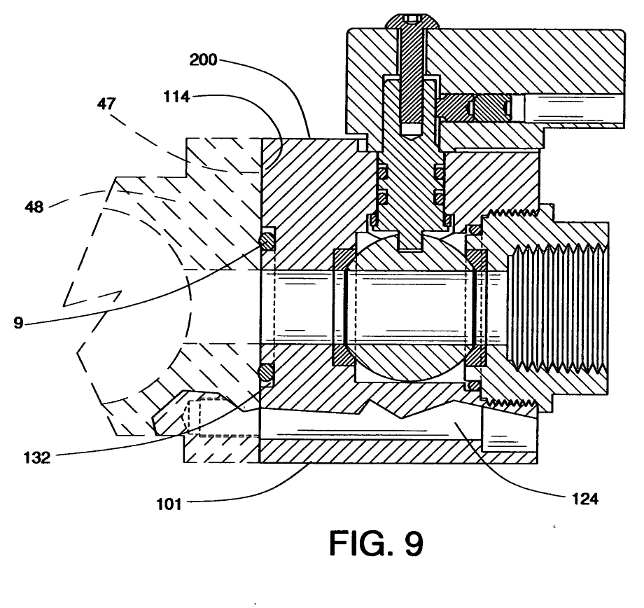

FIG. 9 shows ball valve 200 with its mounting face 114 against a flat face 47 of a manifold 48. Mounting seal 9, on groove 132 of valve body 101, provides a positive seal between valve 200 and manifold 48 when mounting screws (not shown) inserted in mounting holes 124 of valve 200 engaging on the threaded holes of manifold 48 are tightened. The advantages of valve 200, with a flat mounting face, is now apparent over conventional valves with threaded ports when mounting to a manifold or body that has a flat mating surface.

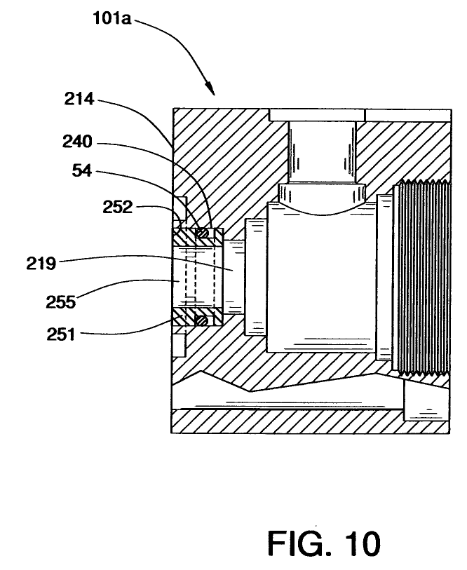

FIG. 10 is a cross sectional view of another embodiment of the valve body shown in FIG. 8. Valve body 101a is very similar to body 101 of valve 200 shown in FIG. 8 except the addition of a flow reducing annulus 251 on the inlet port 219 of body 101a and details will be directed towards these changes herein.

In body 101a, on mounting face 214, hole 219 which forms part of the fluid passageway is counterbored creating recess 240. A removable annulus 251 is provided to fit snuggly in recess 240. The said annulus 251 has an inside diameter 255, alternately called orifice, an outside surface 252 which when assembled should be flush or slightly below surface 214 of body 101a. The said annulus is provided with a groove on the outside diameter for receiving seal 54 to prevent fluid flow bypass and prevents annulus 251 from falling off in during handling. When valve body 101a is used in valve 200, instead of body 101, the said valve 200 of FIG. 8 will have the capability of providing a reduced flow by changing annulus 251 with a smaller orifice.

I claim:

1. A ball valve that mounts onto a flat surface, having fluid communicating ports, namely first port and subsequent port or ports comprising:
a valve body having faces, one of said faces is a mounting face, generally flat, a first cavity on said mounting face defines the location of said first port, said first cavity creating a wall, said wall of said first cavity generally threaded, a second cavity at the base of said first cavity, generally formed by a stepped recess or recesses extending through the second port, said second port located on the face opposite the mounting face, a number of holes, namely mounting holes, disposed near the edges of said valve body, the axes of said mounting holes are generally perpendicular to said mounting face;
a retainer, generally cylindrical in shape, having an outside surface, generally threaded, configured to be received in said first cavity on said mounting face, an inside diameter defining the first port, a first end, and a second end, the said second end, having a groove, generally circular, for receiving a sealing material.

2. A ball valve that mounts onto a flat surface having fluid communicating ports, namely first port and subsequent port or ports comprising:
a valve body having faces, one of said faces is a mounting face, generally flat, said mounting face is the location of said first port, a first cavity on the face opposite the mounting face defines the location of said second port, said first cavity creating a wall, said wall generally threaded, a second cavity at the base of said first cavity, generally formed by a stepped recess or recesses extending through said first port, a groove, generally circular, on said mounting face for receiving a sealing material, and a number of holes, namely mounting holes, disposed near the edges of said valve body, the axes of said mounting holes are generally perpendicular to said mounting face.

3. A retainer as described in claim 1 wherein the inside diameter is counterbored from the second end, said counterbore configured to receive an annulus, said annulus having an inside diameter equal to or smaller than the inside diameter of said retainer.

4. The valve body as described in claim 1 wherein the axes of the ports are oriented in an angular fashion, generally 90 degrees.

5. The valve body as described in claim 1 having said first port and a number of subsequent ports.

6. The valve body as described in claim 1 wherein the mounting face is provided with a groove for receiving a sealing material.

7. The valve body as described in claim 1 having outside portion or portions reduced to form a shape, generally cylindrical, starting at some suitable distance from said mounting face, thereby creating a flange, said flange having the mounting holes of said valve body.

8. The valve body as described in claim 2 having a first port and a number of subsequent ports.

9. The valve body as described in claim 2 wherein the first port is counterbored from the mounting face, said counterbore configured to receive an annulus, said annulus having an inside diameter equal to or smaller than the inside diameter of said first port.

10. The valve body as described in claim 2 having outside portion or portions reduced to form a shape, generally cylindrical, starting at some suitable distance from the mounting face, thereby creating a flange, the said flange having the mounting holes of said valve body.
